(19) United States
(12) Patent Application Publication
(10) Pub. No.: US 2020/0123819 A1
(43) Pub. Date: Apr. 23, 2020

(54) Handle for a Moveable Component of a Motor Vehicle

(71) Applicant: Huf Hülsbeck & Fürst GmbH & Co. KG, Velbert (DE)

(72) Inventor: Dirk Müller, Essen (DE)

(21) Appl. No.: 16/309,844

(22) PCT Filed: May 16, 2017
(86) PCT No.: PCT/EP2017/061747

§ 371 Date: Dec. 13, 2018

(30) Foreign Application Priority Data
Jun. 24, 2016 (DE) 10 2016 111 602.5

(51) Int. Cl. E05B 85/16; E05B 17/10; E05B 79/06

(52) U.S. Cl. CPC E05B 85/16; E05B 63/0056; E05B 79/06; E05B 17/10

(57) ABSTRACT

The present invention relates to a handle (1) for a moveable component of a motor vehicle, comprising
a base body (10), in which a cavity (11) is formed,
wherein an electronics unit (12) for data communication with a security system of the motor vehicle,
and a first sensor (13) for locking a locking system of the motor vehicle are arranged in the cavity (11),
and wherein the base body (10) is configured to accommodate different cover elements (20) for covering the cavity (11).

The invention relates to a handle for a moveable component of a motor vehicle, with a base body, in which a cavity is formed, which body is configured to accommodate an electronics unit for data communication with a security system of the motor vehicle.

Handles, e.g. door handles, are generally known for moveable components such as doors, tailgates or trunks lids and the like in motor vehicles. Known door handles mostly comprise an inner shell and an outer shell. Electronic components and sensors are fastened both to the inner shell and to the outer shell. It turned out to be a disadvantage that the construction and the mounting of such handles is complex. Moreover, different electronic components and sensors must be separately connected at different remote points of the handle. As a consequence, the mounting of such handles must take place in multiple complicated steps. Moreover, such handles must be produced individually for each vehicle model.

For this reason, the object of the present invention is to provide a handle, which at least partially resolves the above-mentioned disadvantages. In particular, the object of the invention is to create a handle which has a simple design, can be easily-mounted and be used flexibly in various vehicle models.

According to the invention, this object is achieved by means of a handle for a moveable component of a motor vehicle having the features of the independent claim 1. Preferred developments of the invention are indicated in the dependent claims. Features disclosed in relation to the individual embodiments of the device according to the invention can be combined in such a way that, with respect to the disclosure, reference can or is always mutually made to the embodiments.

The handle according to the invention, or a door handle according to the invention is formed with a base body, in which a cavity is formed, wherein an electronics unit for data communication with a security system of the motor vehicle and a first sensor for locking a locking system of the motor vehicle are arranged in the cavity, and wherein the base body is configured to accommodate different cover elements for the covering of the cavity. A cover element is per se not part of the handle according to the invention. The base body forms an inner shell of the door handle, which is essentially oriented to a handle recess on the moveable component. An additional cover element can in turn form an outer shell, which is visible from the outside and contributes to the appearance of the motor vehicle.

The inventive idea is that the handle is formed with a standardized base body, in which all electronic components and sensors are fastened, in particular the electronics unit for data communication with the security system of the motor vehicle and the first sensor for locking the locking system of the motor vehicle. Moreover, the second sensor can also be fastened in the standardized base body for the unlocking of the locking system. The inventive idea is that only a few simple steps are required to mount the handle and connect electronic components and sensors here. To that end, the standardized base body is to be mounted on the moveable component and connected in a simple manner according to the invention. To cover and/or seal and/or decorate the handle, in a further step a cover element individual for a certain vehicle model can be attached to the base body. To that end, the base body may comprise different standardized fastening interfaces to different cover elements. In this way, the mounting of the handle of the moveable component can be simplified here. In addition, it is advantageous that the handle can be used in various vehicle models, wherein merely the respective cover element of the certain vehicle model is to be fastened to the handle according to the invention.

Furthermore, it can be in the scope of the present invention that the first sensor can comprise a first actuating region, wherein the first actuating region can be formed on the base body. It is advantageous here that the function of the locking mechanism of the locking system of the vehicle can also be implemented in the base body. The first actuation region can be a part of the surface of the base body. According to the invention, the first sensor can be a capacitive sensor, e.g. a pressure sensor, wherein a sensor electrode of the first sensor can be implemented on the surface of the base body. The surface of the base body is essentially oriented to the handle recess on the moveable component and comprises lateral portions surrounding this cavity in the base body. The first actuation region can advantageously be formed on one of these portions, in order to enable an actuation of the first sensor essentially in the direction parallel to the vehicle body shell. To actuate the first sensor, a user may simply tap on and/or push on the first actuation region to lock the locking system. As a result, a simple actuation of the first sensor can be ensured.

Furthermore, it can be provided in the scope of the invention that the base body can comprise a marking, which can facilitate an actuation of the first sensor. It is advantageous that the marking can indicate the first actuation region, so that a user can find the actuation region in a simple manner. Thus, actuation of the first sensor can be designed in an even simpler manner. In addition, it is conceivable that the marking can at least partially form a sensor electrode. It is advantageous here that multiple functions can be realized using the marking, namely both the simple finding of, as well as the actual forming of the first actuation region. Furthermore, it is conceivable that the marking can be formed as a layer and/or a symbol and/or can be back-lighted.

Furthermore, it can be provided in the scope of the invention that a second sensor for unlocking the locking system of the motor vehicle can be provided, wherein the second sensor can comprise a second actuation region, and wherein the second actuation region can be formed on the base body. In the sense of the invention, it is conceivable here that the second sensor can likewise be a capacitive sensor, e.g. a proximity sensor. The second actuation region can advantageously be formed on the bottom of the base body, which is oriented to the handle recess and essentially vertically to the vehicle body shell. Advantageously an unlocking of the locking system of the motor vehicle can be initiated in that a user can simply reach behind the door handle into the handle recess, which is a natural intuitive movement carried out by a user when actuating the door handle. Thus, a simple, intuitive actuation of the second sensor can be made possible in order to unlock the locking system of the motor vehicle. Moreover, it is advantageous that both the first actuation region and the second actuation region can be formed on the base body. Thus, the standardized base body may advantageously unify both functions, i.e. the locking and unlocking of the locking system of the motor vehicle. It is advantageous here that, by the mounting of the base body on the moveable component, a cable must be laid just once both for the first sensor and the second sensor. The handle according to the invention thus is a self- contained module that includes all electronic components and sensors. The handling and mounting of the handle according to the invention is simplified thereby.

Moreover, it can be provided in the scope of the invention that the base body can comprise a lighting unit that can facilitate an actuation of the second sensor, wherein the lighting unit can be fastened on a second support element. The second support element can be accommodated in the cavity with the lighting unit, wherein the second support element can be mechanically fastened to the base body, e.g. clipped, clamped, screwed, glued, and the like. The lighting unit can comprise one or multiple light-emitting diodes, LED. Advantageously, the lighting unit can be used to illuminate the handle recess, in particular in dark seasons and unlighted rooms, in order to make the first and/or the second actuation region visible. As a result, the user can find and actuate the handle in a simplified manner.

Furthermore, it can be provided in the scope of the invention that a first support element can be provided, in which the electronics unit and/or the first sensor can be fastened. The first support element can be made of plastic, e.g. a thermosetting plastic. The first support element can be accommodated in the cavity together with the electronics unit and the first sensor and be per se mechanically fastened to the base body, e.g. clipped, clamped, screwed, glued or the like. It is advantageous here that the electronics unit and/or the first sensor on the first support element find a corresponding support which they require for their functionality. Here, merely the first support element must be adapted to the shape of the cavity. The first support element advantageously ensures that that shape and the function of the electronics unit and/or the first sensor are not affected during the mounting process.

According to the invention, it is furthermore conceivable that a fastening element can be provided to fasten the first support element and/or the second support element to the base body in a form-fit and/or force-fit and/or adhesive manner. It is furthermore conceivable that the fastening element may serve as a sealing element for the first sensor. The fastening element can e.g. be an adhesive tape, which is arranged around the first sensor to seal the first sensor. The fastening element can advantageously serve to seal the handle toward the inside in the direction of the handle recess. Furthermore, such fastening elements, e.g. clips, clamps, lugs, screws, and the like are conceivable to fasten the first support element and/or the second support element to the base body. It is advantageous here that such simple fastening elements can simplify the assembly of the handle.

Furthermore, it can be provided in the scope of the invention that the cavity can be filled with a casting compound, in particular made of an epoxy resin, after installing the electronics unit, a first sensor, and in particular a second sensor in the base body. Epoxy resin is a light material, which has a high stability after curing. Thus, advantageously, the electronics unit, the first sensor and/or the second sensor can be sealed with respect to the outside and be secured against mechanical influence. In addition it is advantageous that the casting compound can permanently secure the position of the electronics unit and the orientation of the first sensor and/or of the second sensor.

Furthermore, it can be provided in the scope of the invention that the base body can be formed to receive different decorative elements, in particular besides the different cover elements. Thus, the field of application for different vehicle models and the functionality of the handle according to the invention can be expanded. A cover element can represent a sign for a certain vehicle model and/or allow the appearance of the motor vehicle to appear high-quality.

The invention can further provide that the base body can be formed to accommodate a locking cylinder for the manual actuation of the locking system of the motor vehicle and/or can comprise a cover flap for the locking cylinder. This provides the advantage that in the event of a failure of the electronics, the locking system can be actuated mechanically using a key and the locking cylinder, and that the cover flap can cover the lock cylinder in order to not impair the appearance of the handle.

Furthermore, the base body according to the invention can comprise a pulling means for the mechanical actuation of the handle, to open the locking system of the motor vehicle. The pulling means can be formed as a tappet at an end of the handle and be used to guide the handle essentially vertically to the vehicle body shell when pulling out the door handle. The pulling means can be mounted in a linearly displaceable manner in a corresponding guidance in a mounting carrier of the motor vehicle.

In addition, it is conceivable according to the invention that the base body can comprise a pivot means for the pivotable mounting of the handle on the movable component. The pivot means can be pivotably mounted around a pivot axis. Thus, a second end of the handle can be pivotably moved around the pivot axis when actuating the handle, in order to enable a pivoting of the door handle.

It is also conceivable here that the base body can comprise a cover hood with a recess for the pivot means. The cover hood can dampen an abutment of the second end of the handle against a vehicle body shell and prevent the generation of noise when the handle falls back. It is also conceivable that the cover hood can seal the recess for the pivot means towards the inside to the cavity.

Furthermore, the invention can provide that the base body, in particular the pivot means, can comprise a support surface for a connector of the lighting unit. This can allow a simple connection of the lighting unit. Moreover, the invention can provide that the base body, in particular the pivoting means, can comprise a support surface for a plug of the electronics unit. Thus, the cabling of the handle can be simplified. The connector for the lighting unit and the plug for the electronics unit can be positioned closed to one another here. The cabling and the connection of the handle can thus be made possible with simple and only a few steps.

Further measures improving the invention are hereinafter described in more detail in conjunction with the description of a preferred exemplary embodiment of the invention by means of the Figures. The Figures show in:

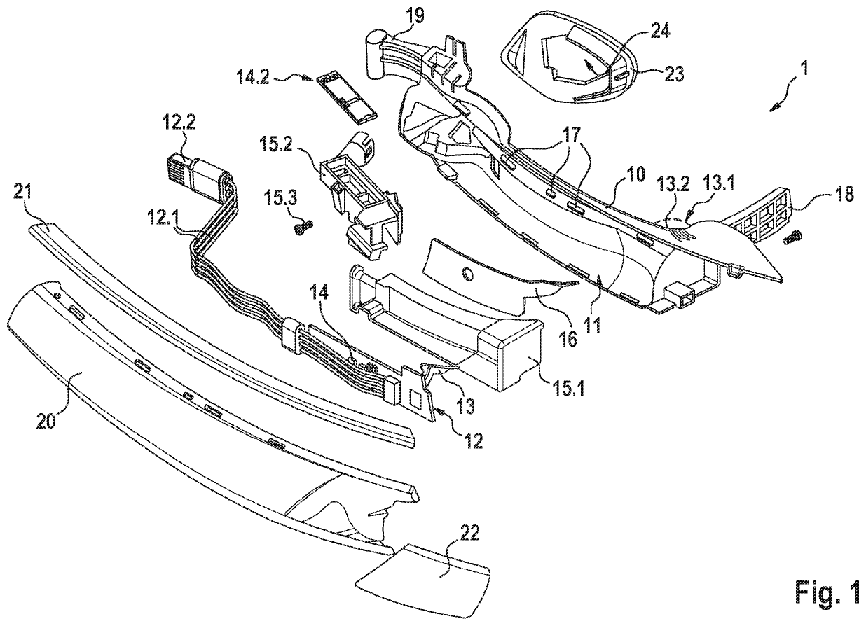

FIG. 1 a handle according to the invention, in an exploded view,

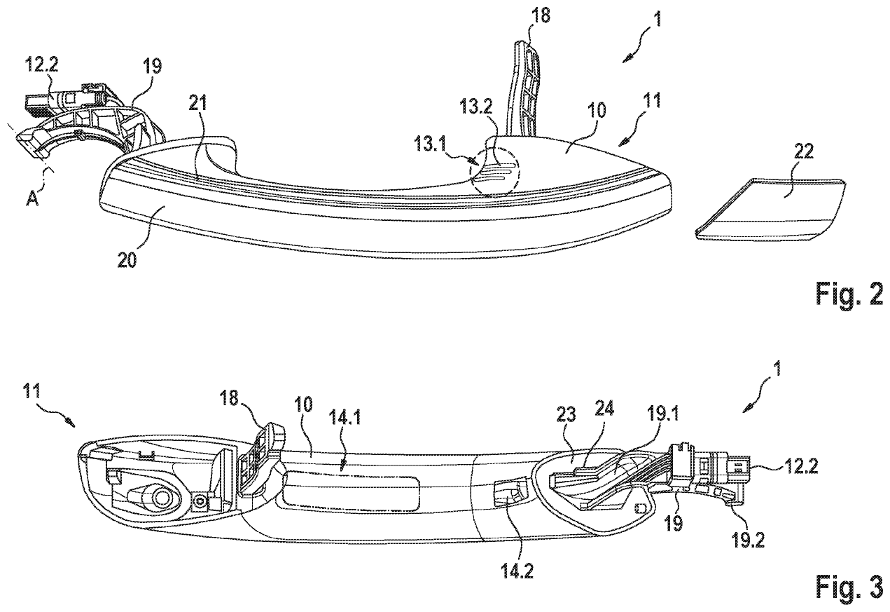

FIG. 2 the handle according to the invention in the assembled state in a view form outside, and

FIG. 3 the handle according to the invention in the assembled state in a view from inside.

Throughout the Figures, identical reference characters are given to the same technical features, wherein each reference character is generally only described once.

FIG. 1 shows a handle 1 according to the invention in the form of an inner shell of a door handle of a motor vehicle. The handle 1 comprises a base body 10, which forms the inner shell of the door handle, and which is oriented to a handle recess on the vehicle. In the base body 10, a cavity 11 is formed, which accommodates all electronic components 12 and sensors 13, 14 for a keyless actuation of a locking system of the motor vehicle. According to the invention, these include an electronics unit 12 for data communication with the security system of the motor vehicle in order to perform an authorization request of a user, a first sensor 13 for locking a locking system of the motor vehicle, and a second sensor 14 for unlocking the locking system of the motor vehicle.

According to the invention, the base body 10 is configured to accommodate different cover elements 20 for covering and, as the case may be, for sealing the cavity 11. The cover element 20 in turn forms an outer shell of the door handle, which is visible from outside and contributes to the individual appearance of the motor vehicle.

The inventive idea is that of providing a standardized base body 10 for various vehicle models, which accommodates all electronics components and sensors of the handle 1, and which encloses the handle 1 in the type of a module in order to allow a simple and quick assembly of the handle 1 as one component as well as a simple and bundled cabling of the electronics unit 12 and sensors 13, 14. According to the invention, only the standardized base body 10 has to be mounted and wired to the moveable component, wherein subsequently, depending on the vehicle model, an individual cover element 20 can be fastened to the base body 10. The base body 10 can comprise a number of different standardized fastening interfaces 17, e.g. in the form of latch hooks, to different cover elements 20. A further advantage of the invention is that the base body 10 also serves to securely fasten all electronic components 12 and sensors 13, 14.

As can be seen in FIGS. 2 and 3, the base body 10 is formed with a first actuation region 13.1 for the first sensor 13 and with a second actuation region 14.1 for the second sensor 14. The first sensor 13 can, according to the invention, be a capacitive sensor, e.g. a pressure sensor. The first actuation region 13.1 can thus act in a manner similar to a sensor electrode of the first sensor 13. The first actuation region 13.1 can thereby be formed on the sides and at the top of the base body 10, so that the first sensor 13 can essentially be actuated in the direction parallel to the vehicle outer shell, or by a simple tapping, in order to lock the locking system of the vehicle. For a more simplified finding of the actuation region 13.1, a marking 13.2 is provided on the base body 10, which indicates the actuation region 13.1. The marking 13.2 may represent an arbitrary symbol, in the example of FIG. 2, a symbol of three short lines is illustrated by way of example. Furthermore, it is conceivable that the marking 13.2 is backlighted. In addition, it is conceivable that the marking 13.2 can be applied as a metal coating and form an electrode of the first sensor 13.

The second sensor 14 also comprises a second actuation region 14.1, wherein the second actuation region 14.1 is likewise formed on the base body 10. In the context of the invention, it is likewise conceivable here that the second sensor 14 can be configured as a capacitive sensor, or a proximity sensor, for example. As shown in FIG. 3, the second actuation region 14.1 can be formed on the bottom of the base body 10, which bottom faces toward the inside and into the handle recess. This is why a user can unlock the locking system by gripping behind the base body 10. This corresponds to a natural movement upon actuating a door handle, and facilitates the actuation of the second sensor 14. This even allows dispensing with any marking of the second actuation region 14.1.

In this way, the invention creates a handle 1, which can be actuated in a simple and intuitive manner. Likewise, the assembly and the mounting of the handle 1 can be made easier in that the cables 12.1, both for the first sensor 13 and for the second sensor 14, can be combined (see FIG. 1).

In order to make the inner area of the handle recess and thus the handle 1 visible in the dark for a user, a lighting unit 14.2 is provided. The lighting unit 14.2 may comprise LEDs here, and can be turned on automatically after detection of an approach of an authorized user.

FIG. 1 further shows a first support element 15.1 and a second support element 15.2, which can each form a support and a support surface for the electronics unit 12 and for the sensors 13, 14 as well as for the lighting unit 14.2. The support elements 15.1, 15.2 are also used to mechanically fasten the electronics unit 12, the sensors 13, 14 and the lighting unit 14.2. The support elements 15.1, 15.2 can, in this case, be made from a plastics material, e.g. injection-molded, and adapted to the shape of the cavity 11, in order to enable a secure fitting of the electronic components in the base body 10. The support elements 15.1, 15.2 can be clipped, clamped, screwed, glued or the like in the base body 10. In the illustrated embodiment of the invention, the second support element 15.2 is fastened on the base body 10 by means of a screw 15.3. In the illustrated exemplary embodiment of the invention, the first support element 15.1 is configured by means of a fastening element 16 in the form of an adhesive strip 16, wherein the adhesive strip 16 also seals the first sensor 13 towards the inside in the direction to the handle recess. In addition, the invention can provide that the cavity 11, after installation of all components, is filled with a casting compound, e.g. of an epoxy resin, in order to seal the electronics unit 12, the first sensor 13 and the second sensor 14 in the direction towards the outside, and secure the positioning of the electronics unit 12 as well as the orientation of the actuation regions 13.1, 14.1.

Furthermore, the base body 10 is formed to accommodate a decorative element 21 in the form of a chrome strip, in order to allow the appearance of the motor vehicle to appear high-quality. The right side in FIGS. 1 and 2 and the left side in FIG. 3 shows that the base body 10 is further configured to accommodate a locking cylinder (not illustrated for the purpose of better illustration) for the manual actuation of the locking system of the motor vehicle. A specific cover flap 22 for a locking cylinder can be fastened on the base body 10 in order to cover the locking cylinder.

The right side in FIGS. 1 and 2 and likewise the left side in FIG. 3 shows that the base body 10 comprises a pulling means 18 on a first end, and a pivoting means 19 on a second end. When pulling out the door handle 10, the pulling means 18 secures the handle 10, and the pivot means 19 allows a partially-pivotable movement of the door handle about a bearing axis A. In this case, the pulling means 18 can be mounted in a linearly-displaceable manner in a corresponding guidance in a mounting support of the motor vehicle, wherein the pivot means 19 can be pivotably-mounted about the bearing axis A. In order to protect a vehicle body shell against a hitting in the re-pivoting movement of the door handle, the base body 10 is formed with a cover hood 23, which comprises a recess 24 for the pivot means 19. In addition, on the pivoting means 19 are formed a support surface 19.1 for a connector of the lighting unit 14.2 and a support surface 19.2 for a plug of the electronics unit 12, which are located close to one another, in order to allow a simple connection of the electronics unit 12 and of the lighting unit 14.2.

### LIST OF REFERENCE CHARACTERS

1 Handle
10 Base body
11 Cavity
12 Electronics unit
12.1 Cable
12.2 Plug for the Electronics Unit
13 First sensor
13.1 First actuation region
13.2 Marking
14 Second sensor
14.1 Second actuation region
14.2 Lighting unit
15.1 First support element
15.2 Second support element
16 Fastening element/adhesive strips
17 Fastening interfaces
18 Pulling means
19 Pivoting means
19.1 Support surface for connector of lighting unit 14.2
19.2 Support surface for plug of the electronics unit 12
20 Cover element
21 Decorative element
22 Cover flap for a locking cylinder
23 Cover hood for a recess
24 Recess for the pivoting means
A Bearing axis/pivoting axis

1-15. (canceled)

16. A handle for a moveable component of a motor vehicle, comprising
a base body, in which a cavity is formed,
wherein an electronics unit for data communication with a security system of the motor vehicle, and a first sensor for locking a locking system of the motor vehicle are arranged in the cavity, and wherein the base body is configured to accommodate different cover elements for covering the cavity.

17. The handle according to claim 16,
wherein
the first sensor comprises a first actuation region, wherein the first actuation region is formed on the base body.

18. The handle according to claim 16,
wherein
the base body comprises a marking, which facilitates an actuation of the first sensor.

19. The handle according to claim 16,
wherein
a second sensor for unlocking the locking system of the motor vehicle is provided, wherein the second sensor comprises a second actuation region, and wherein the second actuation region is formed on the base body.

20. The handle according to claim 16,
wherein
the base body comprises a lighting unit, which facilitates an actuation of the second sensor, wherein the lighting unit is attached to a second support element.

21. The handle according to claim 16,
wherein
a first support element is provided, on which at least the electronics unit or the first sensor is/are fastened.

22. The handle according to claim 16,
wherein
a fastening element is provided to fasten at least the first support element or the second support element on the base body in at least a form-fit or force-fit or adhesive manner.

23. The handle according to claim 16,
wherein
the cavity is filled with a casting compound.

24. The handle according to claim 16,
wherein
the base body is configured to accommodate different decorative elements.

25. The handle according to claim 16,
wherein
the base body is configured to at least receive a locking cylinder for the manual actuation of the locking system of the motor vehicle or comprises a cover flap for the locking cylinder.

26. The handle according to claim 16,
wherein
the base body comprises a pulling means for the mechanical actuation of the handle to open the locking system of the motor vehicle.

27. The handle according to claim 16,
wherein
the base body comprises a pivoting means for the pivotable mounting of the handle on the moveable component.

28. The handle according to claim 16,
wherein
the base body comprises a cover hood with a recess for the pivoting means.

29. The handle according to claim 16,
wherein
the base body, comprises a support surface for a connector of the lighting unit.

30. The handle according to claim 16,
wherein
the base body, comprises a support surface for a plug of the electronics unit.

31. The handle according to claim 22,
wherein
the fastening element is formed as a sealing element for the first sensor.

32. The handle according to claim 23,
wherein
the cavity is filled with an epoxy resin.

33. The handle according to claim 29,
wherein
the pivoting means comprises a support surface for a connector of the lighting unit.

34. The handle according to claim 30,
wherein
the pivoting means comprises a support surface for a plug of the electronics unit.
